(19) United States
(12) Patent Application Publication
(10) Pub. No.: US 2010/0070425 A1
(43) Pub. Date: Mar. 18, 2010

(54) ECOSYSTEM VALUE STREAM OPTIMIZATION SYSTEM, METHOD AND DEVICE

(76) Inventor: Alan Bruce Cornford, West Vancouver (CA)

Correspondence Address: Alan Cornford, 1638 24th Street, West Vancouver, V7V 4W8, omitted

(21) Appl. No.: 12/344,350

(22) Filed: Dec. 26, 2008

Related U.S. Application Data
(60) Provisional application No. 61/016,701, filed on Dec. 26, 2007.

(51) Int. Cl. G06Q 99/00

(52) U.S. Cl. 705/348

(57) ABSTRACT

A method, system and device define a common enterprise framework that aligns many major architecture and process reference models in the prior art. The method utilizes loosely coupled arrangements of common building blocks for defining process stream flows, process stream flow interdependencies and process knowledge benchmarks for both structure and process maturity. The framework system and method facilitate assessment of process flow stream value and value tradeoffs that management may use for optimizing competitiveness value within enterprises and federations of enterprises.

### BACKGROUND OF THE INVENTION

1. Field of the Invention

A method, system and device define a common enterprise framework that aligns many major architecture and process reference models in the prior art. The method utilizes loosely coupled arrangements of common building blocks for defining process stream flows, process stream flow interdependencies and process knowledge benchmarks for both structure and process maturity. The framework system and method facilitate assessment of process flow stream value and value tradeoffs that management may use for optimizing competitiveness value within enterprises and federations of enterprises.

2. Background Information

Enterprises may be defined in terms of an ecosystem framework comprised of architecture and processes. Architecture describes a structure within which processes operate. Processes are sequences of activities that use resource inputs to produce valued outputs. Value streams are highly structured processes and partners that together create or produce flows of outputs satisfying customer or market needs.

Various arrangements of common building blocks may define types of process value streams and value stream flows. Numerous interdependencies among processes require that tradeoffs be made among process resources and flows for optimizing overall enterprise output value. To do this effectively a common architecture and process framework is required to define a standard set of enterprise processes that may provide for ‘interoperability’ among enterprise management applications. These include enterprise resource planning (ERP), supply chain management (SCM), product lifecycle management (PLM), customer relations management (CRM) and other enterprise management systems.

In prior art there are examples of ‘operations reference models’ and methods aimed at standardizing definitions and descriptions of enterprise architectures and business processes. However, as yet there is no single generally accepted common standard. This invention provides a common method that facilitates standardization and that may align the major operational reference models in the prior art.

There are also efforts in the prior art to define best practice benchmark key performance indicators (KPIs) and methods for optimizing ‘maturity’ via re-engineering of architecture and processes. There are also methods aimed at optimizing workforce productivity, innovative capacity, value chain leverage and overall enterprise competitiveness. None of these has as yet become an accepted standard.

‘Benchmarking’ practices in the prior art focus mainly on comparative assessments of aggregate ‘workflow’ and ‘cash flow’ performance indicators. They usually compare aggregate results of many processes for similar types of enterprises (mainly concentrating on the supply chain measures). They rarely focus on ‘process knowledge’ benchmarks that define ‘building block’ process flow maturity or process flow interdependency relationships which must be understood in order to implement corrective action.

This invention provides a method, system and apparatus for common definition of architecture, processes, process knowledge benchmarks, value streams, value stream flows, process value stream flow interdependencies and the types of tradeoffs that may enhance value outcomes. It provides a common framework within which all of these may be integrated for development of interoperable management applications.

3. Prior Art

The prior art describes (a) enterprise architecture reference models and structures, (b) business processes reference models and classifications, (c) maturity methods, (d) value assessment methods and (e) building block and component models.

The prior art describes several enterprise architecture reference models. These include the Zachman framework The Open Group Architecture Framework (TOGAF) the Department of Defense Architecture Framework (DoDAF) FEAF; MDA; ARTS and the Service-oriented architecture reference model (SOA/RM).

The prior art also provides a number of general descriptions of enterprise structure. For example U.S. Pat. No. 7,020,697 1 dated Mar. 28, 2006 by Goodman et al describes an enterprise architecture for net centric computing systems; and US Patent Application Publication US 2006/0136275 A1 dated Jun. 22, 2006 by Cotora describes a method and device for optimizing company structure.

The prior art describes several business process architecture operations reference models. These include the Supply Chain Council operations reference model (SCOR), the Value Chain Group value reference model (VRM), the Federated Enterprise Reference Architecture (FERA), the Intel Integrated Process and Technology Framework (IPTF) and the American Productivity and Quality Committee Process Classification Framework (APQC/PCF).

The prior art also contains several additional process frameworks including US patent Application Publication US 2007/0038490 A1 dated Feb. 15, 2007 by Joodi which describes a method and system for analyzing business architecture; and US Patent Application US 2007/0022404 A1 dated Jan. 25, 2007 by Zhang et al which describes a process profiling framework.

The prior art describes several maturity methods. Examples include US Patent Application Publication US 2007/0021967 A1 by Jaligama related to the concept of measuring and mapping process maturity levels; US Patent Application Publication US 2005/0159965 A1 of Mann et al describes measurement groups; US Patent Application 2006/0136275 A1 of Cotora describes internal and external value production; U.S. Pat. No. 7,136,792 B2 of Baltz et al describes subjective scoring systems; and US Patent Application US 2007/0027734 dated Feb. 1, 2007 of Hughes describes an enterprise design solution methodology for increasing the maturity level of value chains. There are also maturity methods applied by PRTM Inc., AMR Research Inc., the US Productivity Council and GPT Management Ltd. for innovative capacity as described in U.S. Provisional Patent Applications 60/774,597 Feb. 21, 2006 and 11/676,305 Feb. 18, 2007 by Cornford.

The prior art provides examples of framework considerations for assessing process value chains, process interdependences and types of value grid relationships. These include U.S. Pat. No. 7,206,751 B2 dated April 2007 by Hack et al that describes a value chain optimization system; U.S. Pat. No. 7,231,400 dated Jun. 12, 2007 by Cameron et al which describes hierarchies of inter-object relationships based on object attribute values; US Patent Application Publication US 2005/0165822 dated Jul. 28 2005 by Yeung et al which describes systems and methods for business process automation, analysis and optimization; US Patent Application Publication US 2005/0159965 dated Jul. 21, 2005 by Mann et al which describes business analysis and management systems utilizing enterprise metrics; and US Patent Publication Application US 2002/0184067 dated Dec. 5, 2002 by McLean et al which describes a method for measuring and reporting on value creation performance that supports real-time benchmarking.

There are discussions in the prior art literature regarding methods of enterprise value assessment. These include work by A. Lemus (Johnson and Johnson ASP): Metrics for Monitoring New Product Development, 2003; A. Lemus (Ameriquest Mortgage Co.): Change Management in New Product Development (‘Making it Work’), 2004; D. Hofman (AMR Research Inc.): ‘The Hierarchy of Supply Chain Metrics, Supply Chain Management Review Sep. 1 2004; D. Hofman and J. Hagerty (AMR Research Inc.): Defining a Measurement Strategy Part I, BI Review Magazine, Mar. 1 2006; Part II, May 1, 2006; Part III, August 2006; K. Frits and M. Holweg: Evolving from the Value Chain to Value Grid, MIT Sloan Management Review, Summer 2006, Nol. 47, No. 4 pp. 72-79, Reprint 47414; A. Cornford, edited by R. Lipsey (Atlantic Canada Opportunities Agency): Benchmarking Innovative Capacity: Policy and Practice 2005 and Innovate America (US Council on Competitiveness): National Innovation Initiative and Summit Report 2004, ISBN 1-889866-20-2.

Prior art describes the use of ‘loosely coupled’ ‘building blocks’ and ‘component business models’ as a basis for defining modular architectures, processes and process service components for service-oriented architectures. These include G. Pohle, P. Korsten and S. Ramamurthy, 2005 (IBM Business Consulting Services): Component Business Models—Making Specialization Real; P. Salz (Accenture): A Modular Approach, 2006; D. Frenkel (SAP): A Convergence of Business and IT Thinking”: SOA and the Business-IT Divide, MDA (Model Drive Architecture) Journal January 2007; and B. Jaruzleski, K. Dehoff and R. Bordia (Booz, Allen, Hamilton): Smart Spenders: The Global Innovation 1000, S&B 06405, November 2006.

This invention aligns many of these major features in the prior art—architecture and process reference models, benchmarks, maturity methods, value streams flows and value grids, and building block component models in a single common framework representation, set of definitions and process ontology. This unification is unique to the prior art and provides a basis for standard interoperable design of management applications for federation of enterprise ecosystems.

### DESCRIPTION OF DIAGRAMS

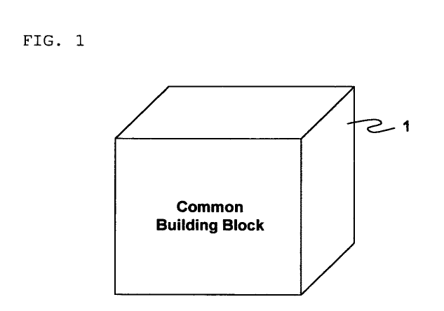

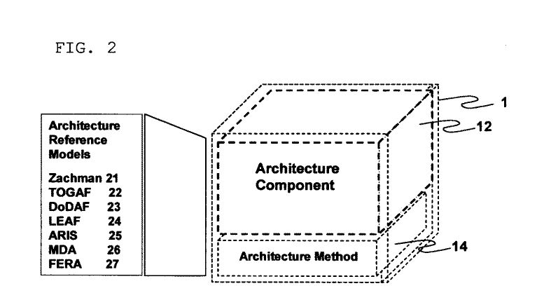

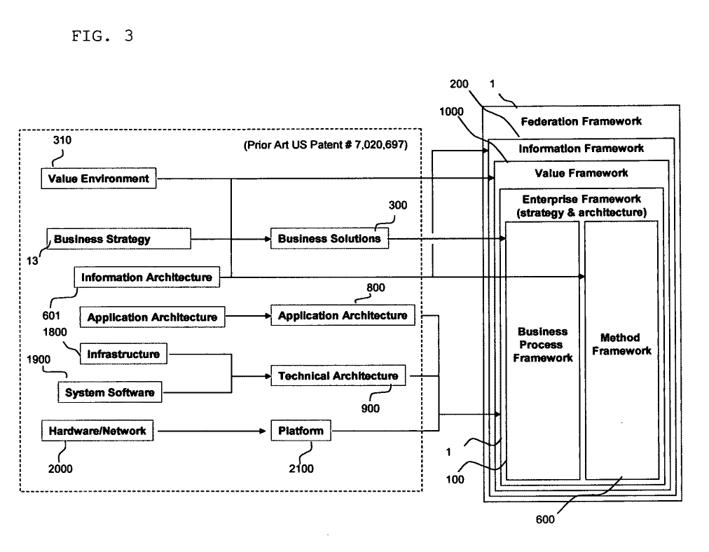

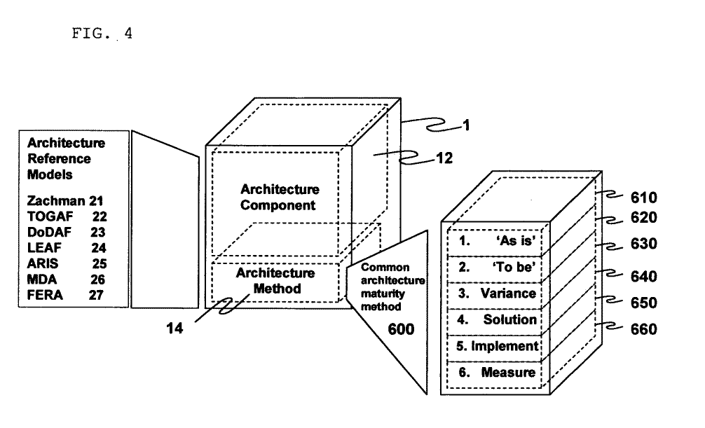

FIG. 1A shows the common building block.

FIG. 1B shows the common building block architecture structure component and method component for architecture maturity re-engineering.

FIG. 1C shows examples of architecture reference models and their alignment with the common building block architecture.

FIG. 1D shows an example of enterprise architecture components in the prior art as they align with common building block structure.

FIG. 1E shows the architecture structure and common set of architecture re-engineering maturity method steps.

FIG. 1F shows alignment of architecture reference models with the six common architecture maturity method steps.

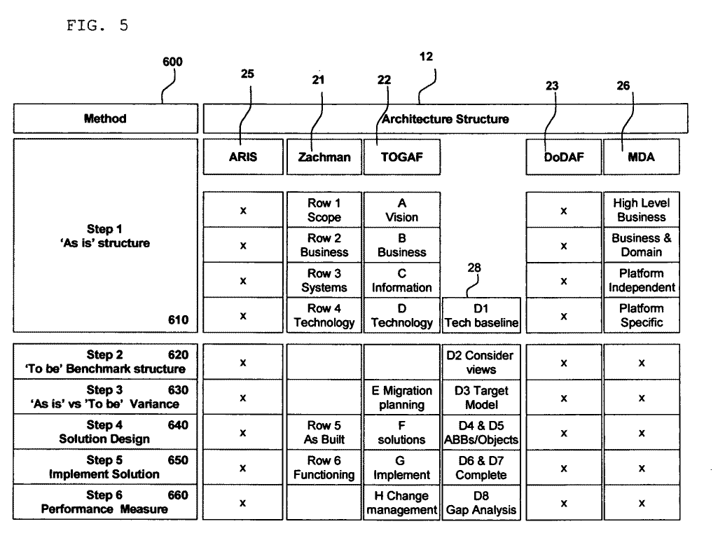

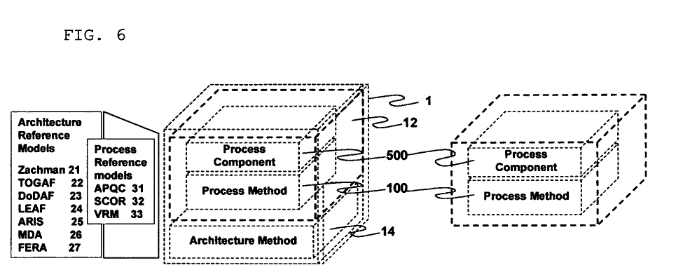

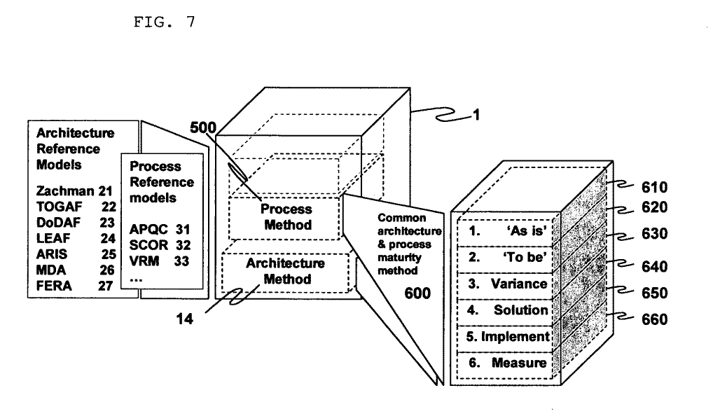

FIG. 2A shows the common building block architecture sub-structure process and process maturity method components.

FIG. 2B shows examples of both architecture and process operations reference models and their maturity method alignment with the six common steps in the common maturity method.

FIG. 2C shows alignment of architecture, process, value stream and competitiveness models in the prior art with the six steps in the common maturity method.

FIG. 2D shows the succession of the six steps in the common maturity method.

FIG. 2E shows the common building block framework structure with the six steps in the maturity method as they relate to a ‘nested set’ of competitiveness value within value streams, within processes, within architecture within the common building block framework.

FIG. 2F shows the same six common sub-steps as they apply to each of the six steps in the common maturity model, with an example for ‘to be’ benchmarks, step 2.

FIG. 2G shows a 6×6 matrix of the steps and sub-steps in the common maturity method as it applies to architecture, process, value stream and competitiveness re-engineering.

FIG. 3A shows the process component common process categories—management, core and enabling.

FIG. 3B shows examples of 4 macro processes that relate to the management process category.

FIG. 3C shows examples of 4 macro processes that relate to each of the 3 process categories.

FIG. 4A shows the 12 major processes of the enterprise with 4 management processes, 4 core processes related to demand and supply and 4 enabling resource processes.

FIG. 4B shows types of management applications that relate to each process and the business process management applications that address all processes.

FIG. 4C shows examples of competitiveness value streams for innovative capacity competitiveness, collaborative leverage competitiveness, and workforce productivity competitiveness that together provide strategic competitiveness.

FIG. 5A shows flow inputs and outputs for the common building block.

FIG. 5B shows three major types of flows—workflow, information flow and value flow.

FIG. 5C shows each of these types of flows in three dimensions for each building block.

FIG. 6A shows ‘stage-to-stage’ flows within processes.

FIG. 6B shows ‘level-to-level’ flows within process re-composition levels

FIG. 6C shows ‘process-to-process’ flows between processes

FIG. 6D shows all three types of flows as well as examples of activity-to-element flows and element-to-conformation flows.

FIG. 6E shows types of flow interdependencies including stage-to-stage, level-to-level, process-to-process at the activity-to-activity level and at the process activity-to-process element level.

FIG. 7A shows a ‘nested set’ of process building blocks within building blocks for various levels of process de-composition and re-composition.

FIG. 7B shows sets of levels—activity, element, conformation and macro process—associated with re-composition of each process within the ‘nested set’ of processes.

FIG. 7C shows service oriented-architecture (SOA) building block process service components.

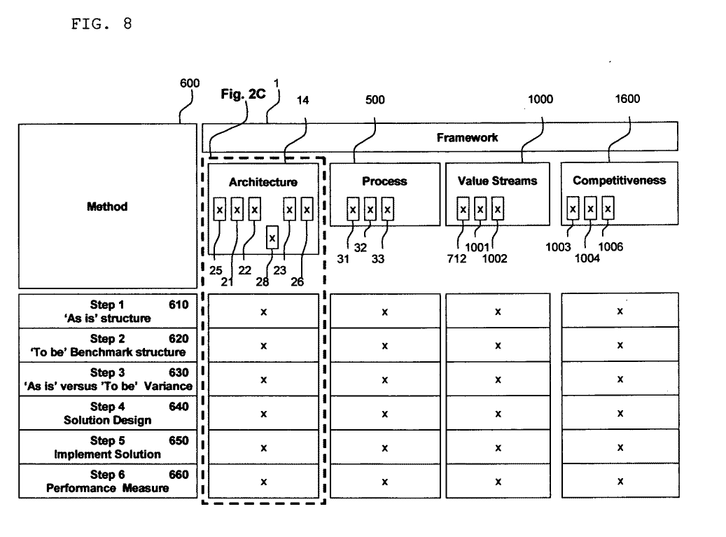

FIG. 8A shows the examples of building block interdependencies in FIG. 6E and examples of some of these related to enterprise processes.

FIG. 8B shows the examples of building block interdependencies between management (strategy) process and core processes and between core processes and enabling (resource) processes.

FIG. 8C shows an example of public enterprise and private enterprise research and development interdependencies in a federation of public and private enterprises.

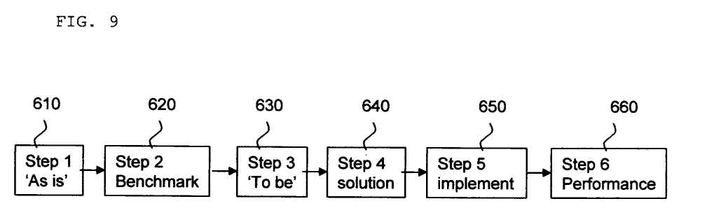

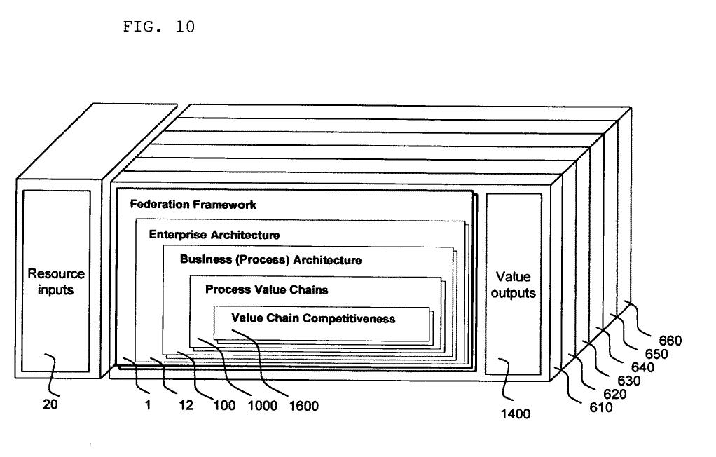

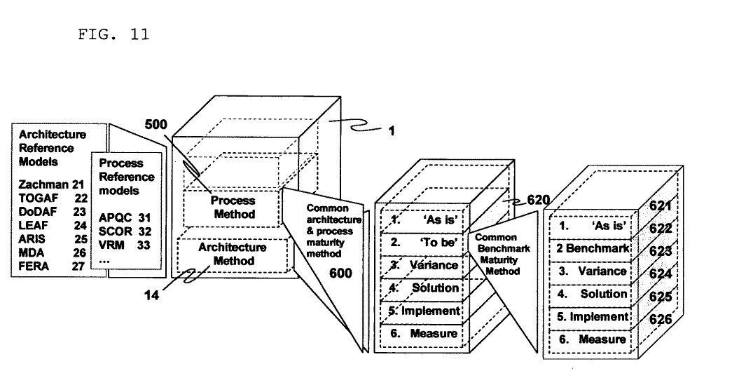

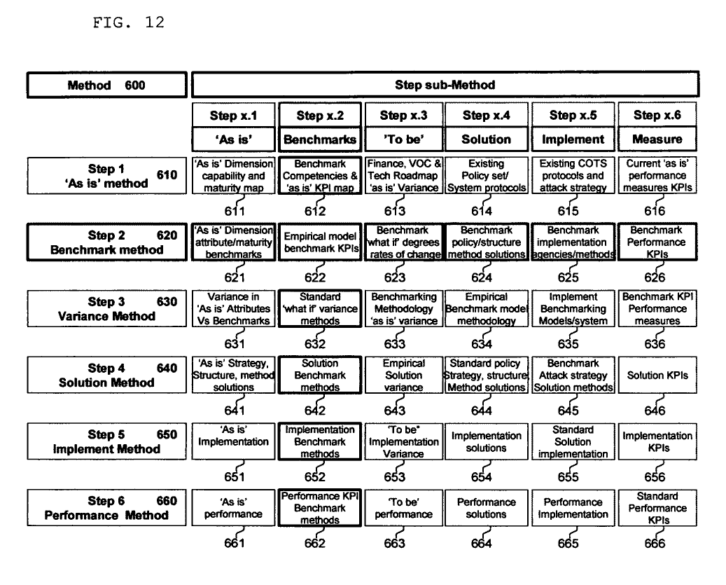

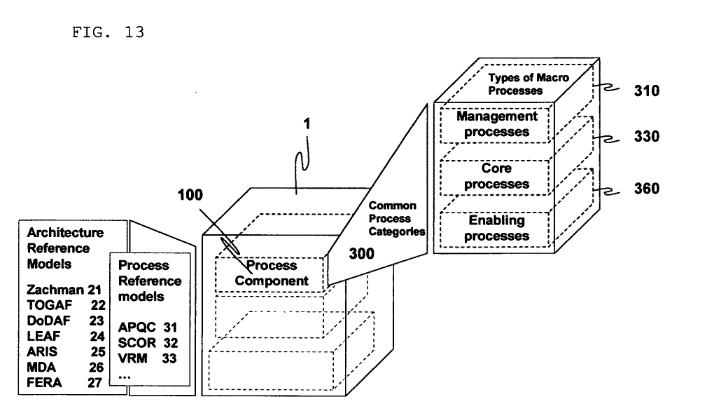

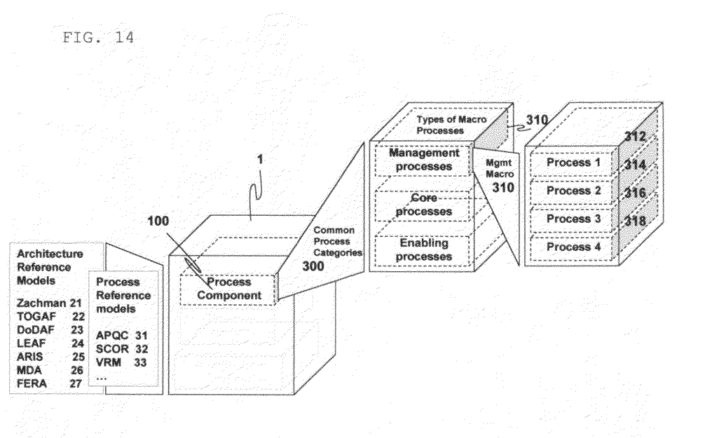

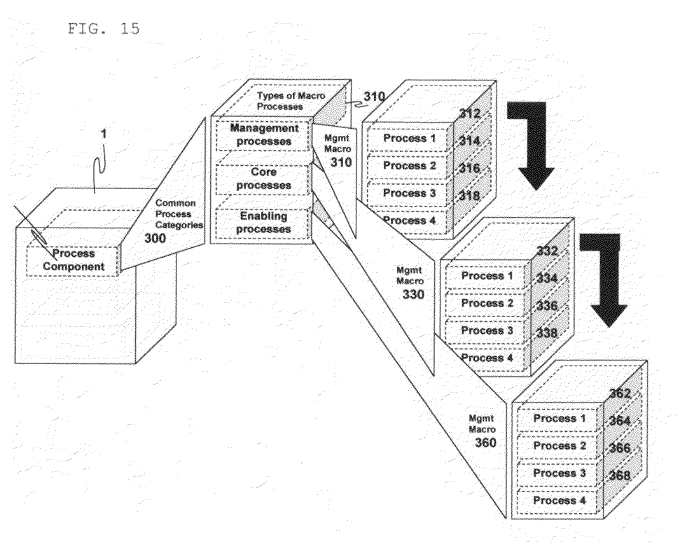

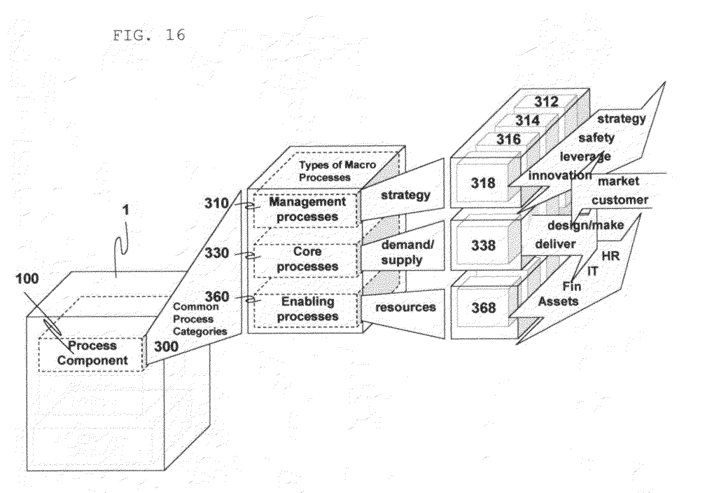

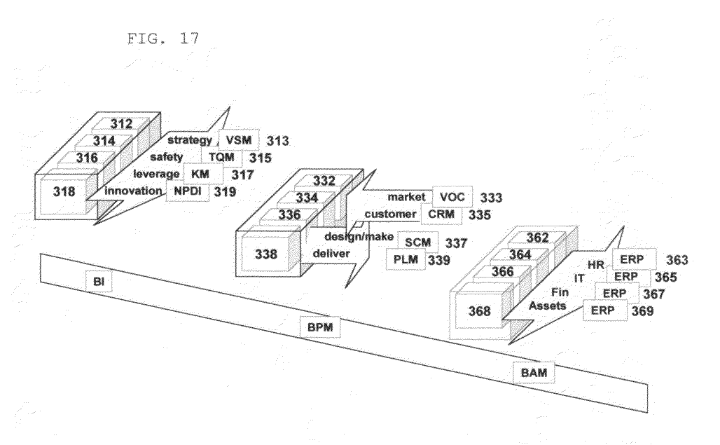

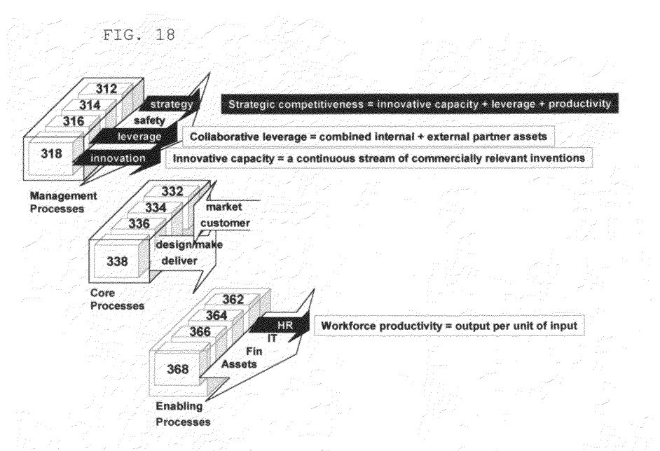

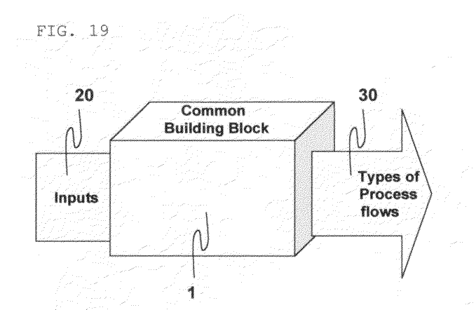

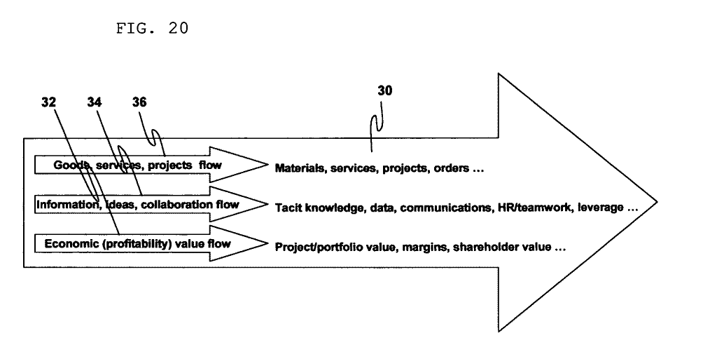

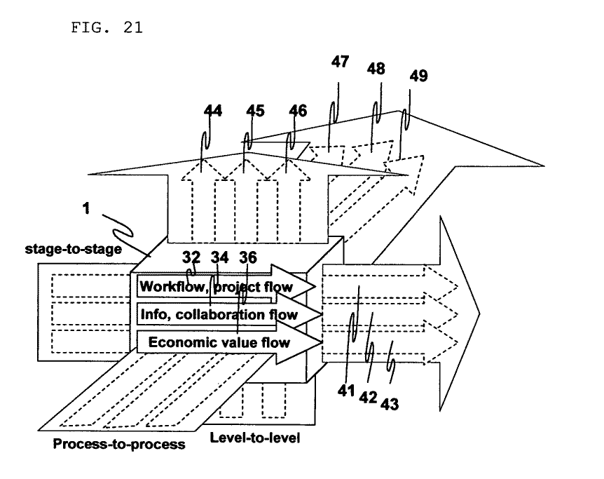

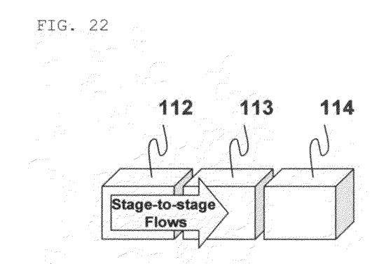

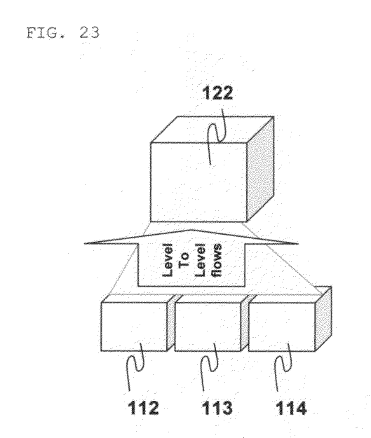

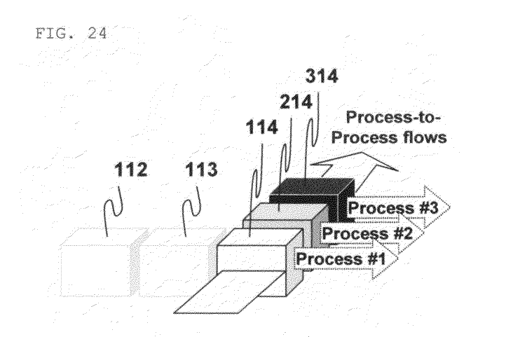

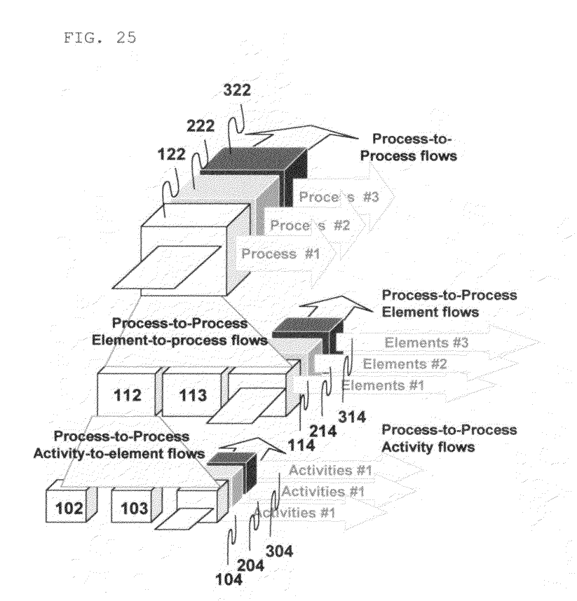

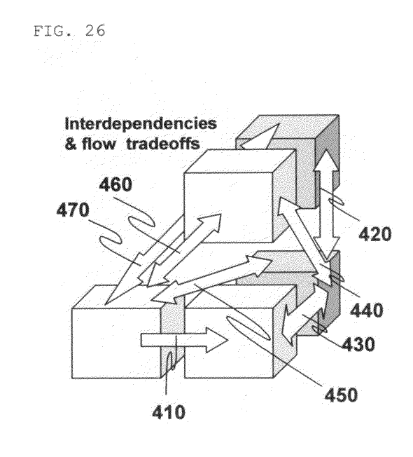

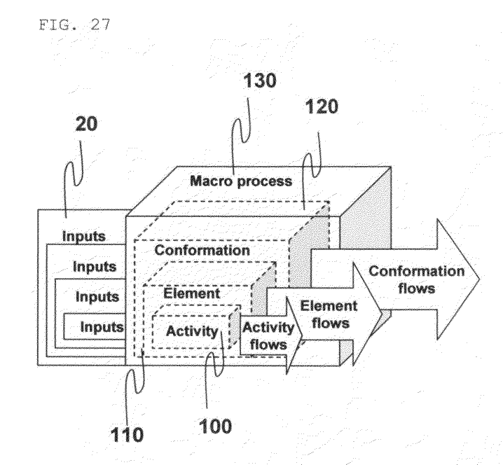

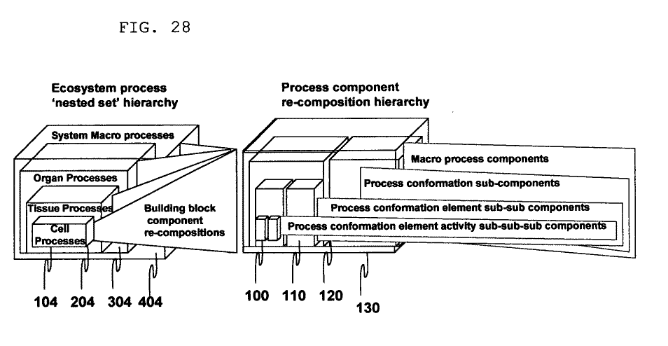

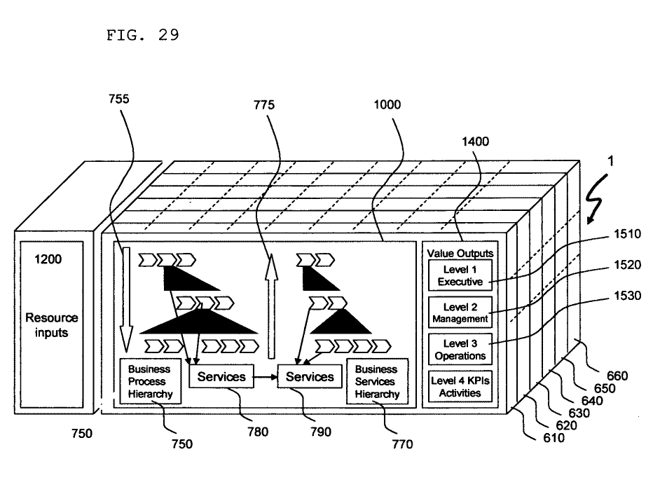

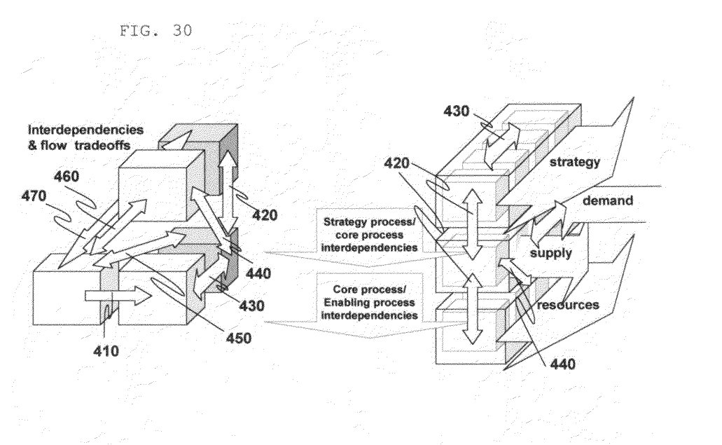

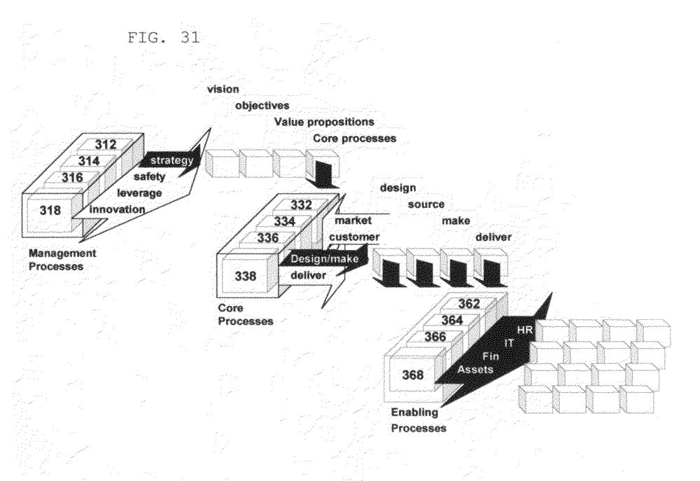

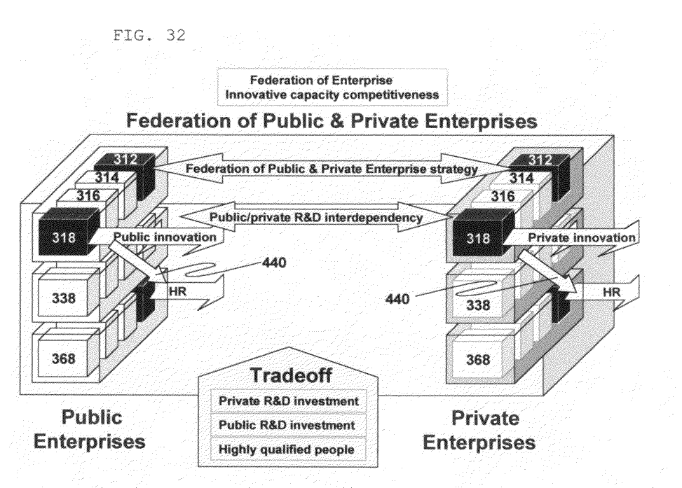

FIG. 9 shows innovative capacity process stream flow inter-relationships.

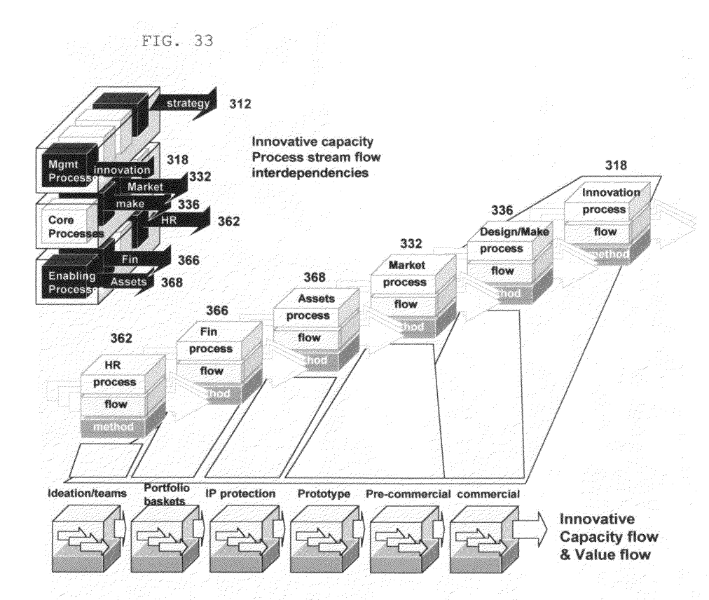

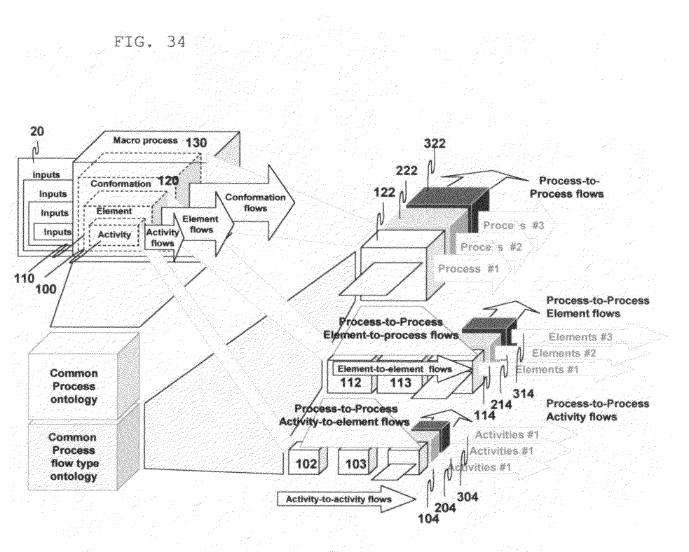

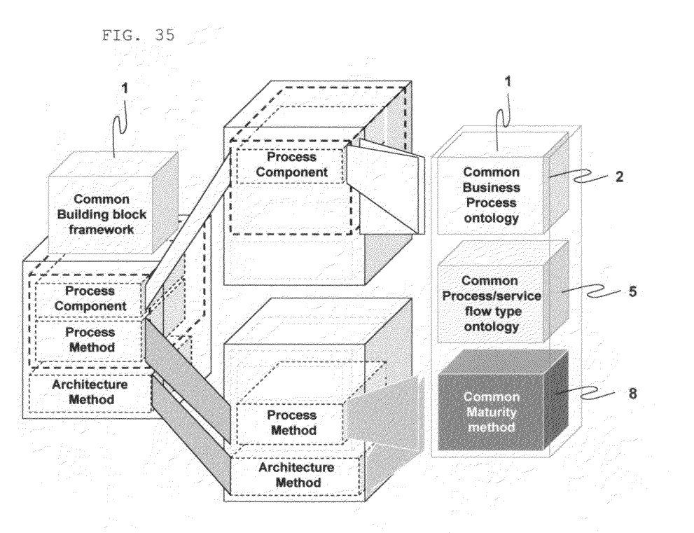

FIG. 10A shows a common building block process ontology as it relates to FIG. 7A and a common process flow ontology as it relates to FIG. 6E.

FIG. 10B shows a common process ontology, a common process flow ontology and a common maturity method.

FIG. 10C shows the elements of a device that include a process ontology, process arrangements and process tradeoffs; flow type ontology, macro process flows (stage-to-stage and level-to-level), and process-to-process tradeoff flows; maturity method, process benchmark knowledgebase and process tradeoff benchmark knowledgebase.

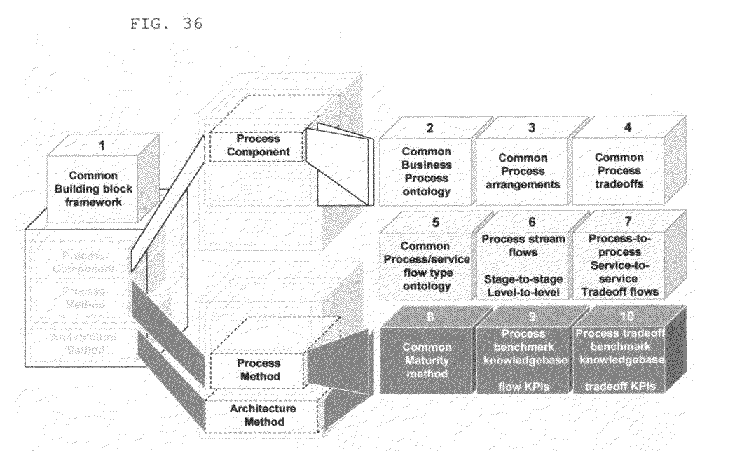

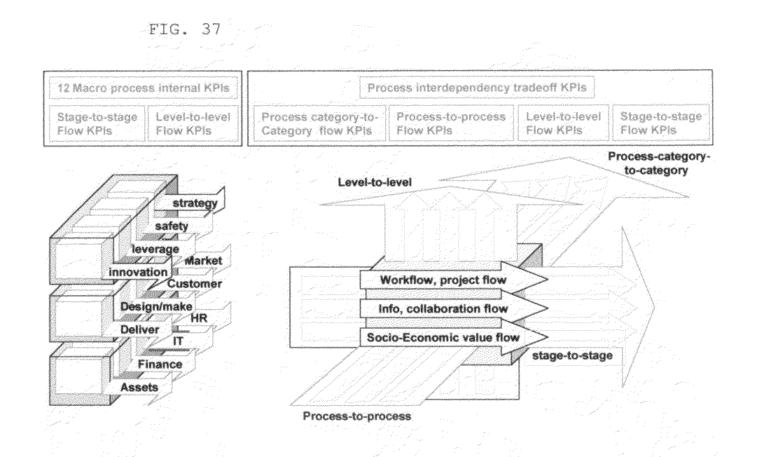

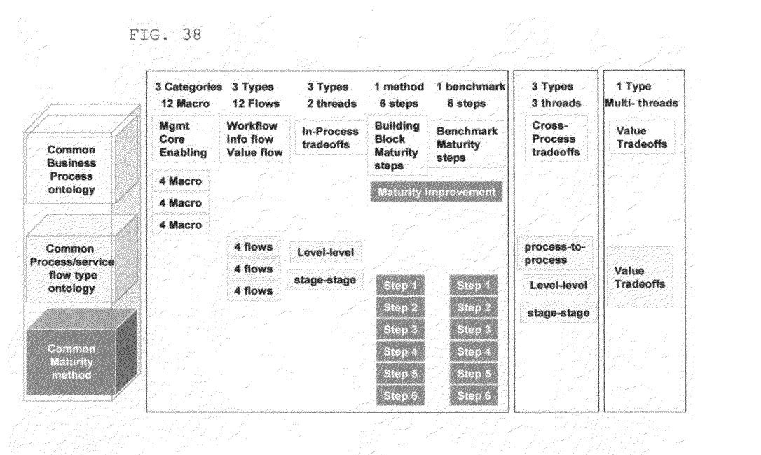

FIG. 11A shows a device for monitoring key performance indicator (KPI) metrics within processes and for process interdependencies and decision tradeoffs.

FIG. 11B shows categories of key performance indicators.

### SUMMARY OF THE INVENTION

The invention provides a method, system and device for defining and measuring enterprise ecosystem value. Major features of the overall system include: (a) common building block framework; (b) alignment of prior art operations reference models and management applications with a common maturity method and common process ontology; (c) common flow streams and flow types; (d) common building block flow stream arrangements and (e) process interdependencies and value stream tradeoffs.

### 1. Common Building Block Framework

This invention defines a common building block framework. The framework is ‘process centric’. It is based upon arrangements of loosely coupled building blocks for defining processes, process services, process stream flows and process interdependencies. While every ecosystem is different, all building blocks have a common set of structure, process and re-engineering method components.

FIG. 1A shows the common building block framework 1. The framework is comprised of an architecture component 12 and a ‘maturity’ method component for architecture re-engineering 14 shown in FIG. 1B.

There are many descriptions of enterprise architecture structure in the prior art. The structure in U.S. Pat. No. 7,020,697 B1 dated Mar. 28, 2006 by Goodman et al is shown in the left portion of FIG. 1D as it aligns with this invention in the right portion. Common aspects include business (process) strategy 13, information architecture 601, application architecture 800, technical architecture 900 and value environment 1010.

### Common Architecture Ontology and Maturity Method

The framework in this invention provides both a common structure 12 and a common architecture maturity method 14 that aligns the major architecture reference models in the prior art including Zachman 21, TOGAF 22, DoDAF 23, LEAF 24, ARTS 25, MDA 26, and FERA 27 shown in FIG. 1C. Not all of these models define architecture components, dimensions and dimension attributes in the same way; the number of maturity steps ranges between 2 and 8 and not all steps are undertaken in the same order. However the intent in all the models may be satisfied by a common maturity method defined in this invention that is comprised of 6 steps.

The six steps in the method include step 1 definition of the ‘as is’ state (both architecture and process) 610; step 2 definition of the desired ‘to be’ state and benchmarks for that state (so both architecture and process can be the best they can be) 620; step 3 definition of the variance between them 630; step 4 definition of a solution to address part or all of the variance 640; step 5 definition of a means to implement a solution 650; and step 6 definition of measure(s) of improved performance 660 as shown in FIG. 1E.

### 2. Common Process, Value and Competitiveness Maturity Method

The architecture component 12 is further comprised of a process component 100 and a ‘maturity’ method component 500 for process re-engineering shown in FIG. 2A. Despite variation in definitions of processes and steps in maturity methods, models including APQC 31, SCOR 32, and VRM 33 may be aligned with the same six common maturity steps for architecture maturity as shown in FIG. 2B.

These common maturity method steps in FIG. 2D not only apply to architecture and processes but also to value streams, innovative capacity, productivity and leverage competitiveness shown in FIG. 2C and shown as a ‘nested set’ in FIG. 2E.

Each of the six steps in the common maturity method has a similar set of six sub-steps for optimizing maturity within each step. The six sub-steps 621-626 for benchmarks 620—step 2 that defines the targets for the most desired ‘to be’ state—are shown in FIG. 2F. These provide a basis for defining a standard process benchmark ‘knowledgebase’ in the invention device shown in FIG. 10C.

### 3. Common Process Ontology

Processes convert inputs to valued outputs. They may be categorized into three process types 300—‘management’ processes 310 that set strategy; ‘core’ processes 330 that balance demand with supply; and ‘enabling’ processes 360 that provide the right mix and balance of resources. These are shown in FIG. 3A.

Each of these 3 enterprise process types has 4 macro processes shown in FIGS. 3B and 3C. For example, the 4 management processes include strategy 312, safety 314, leverage 316 and innovation 318 processes. The 4 ‘core’ processes define demand and supply including demand 332, market 334, design/make 336 and deliver/return 338 processes. The 4 ‘enabling’ resource processes include human resources 362, information technology resources 364, financial resources 366 and capital asset resources 368 shown in FIG. 4A.

Examples of software applications in the prior art that facilitate process management for each of these 12 processes are shown in FIG. 4B. For management processes these include value strategy management (VSM) and business planning 313, total quality (health, environment and safety) management (TQM) 315, leverage knowledge management (KM) 317, and innovation and new product development and introduction (NPDI) 319.

‘Core’ process applications include voice of customer (VOC) 333, customer relations management (CRM) 335, supply chain product/service management (SCM) 337, and product/service lifecycle management (PLM) 339.

Enabling process applications for human, information, finance and asset resources are aspects of enterprise resource planning (ERP) 363, 365, 367 and 369. Business process management (BPM) 396, business activity monitoring (BAM) 391 and business intelligence (BI) 393 help facilitate process knowledge integration across all applications.

While all macro processes contribute to enterprise competitiveness, innovation, leverage and workforce productivity processes drive strategic competitiveness value flow as shown in FIG. 4C.

### 4. Common Value Stream Flow Ontology

Process building blocks convert inputs 20 to desired outputs via process flow streams 30 shown in FIG. 5A. Sequences of building blocks define types of flows as shown in FIG. 5B. ‘Workflow’ 36—includes goods, services, ideas, projects and may also be described as ‘deal ’ flow; ‘information flow’ 34—includes knowledge, data, collaborations, and team communication flow; and ‘value flow’ 32—includes ‘workflow’ and ‘information flow’, as well as cash, revenues, profits, shareholder value and other forms of value.

Most enterprise software applications facilitate process ‘workflow’ conversions and related transactions. Some also facilitate ‘tacit knowledge’ flow. Few track value flow which is produced by many different combinations of flows within and across inter-dependent processes.

### 5. Stream Flow Building Block Arrangements

There are several major types of building block process stream flow arrangements. Orientations of building block flows may be stage-to-stage 32, 34, and 36, level-to-level 44, 45, and 46, and process-to-process 47, 48, and 49 as shown in FIG. 5C.

‘Value flows’ include ‘stage-to-stage’ flows block-to-block, for example 112 to 113 to 114 and end-to-end within individual processes as shown in FIG. 6A. There are ‘level-to-level’ flows within processes where sets of blocks such as 112, 113 and 114 may generate aggregate flow up to the next process re-composition level 122 shown in FIG. 6B. Level-to-level flows may occur for activity-to-element, element-to-conformation, conformation-to-process or any combination of these as shown in FIGS. 6D and 7A.

There are also ‘process-to-process’ flows, for example from 114 (process 1) to 214 (process 2) and/or to 314 (process 3) among processes. These types of flows may occur simultaneously at all organizational levels as shown in FIG. 6D. The flows may also involve cross-process flows among different levels and at different stages such as flows 440, 450, 460 and 470 shown in FIG. 6E.

The number of combinations and permutations and hence the complexity of flow stream pathways and process interdependency flow pathways is quite large in all ecosystems. For example, in the human body ecosystem, there are 12 building block systems akin to the 12 macro processes 130 in the enterprise shown in FIG. 7A. Within each system 404 there are organs 304 made up of tissues 204 which in turn are made up of cells 104—a ‘nested set’ of processes and sequences of process building blocks.

In all ecosystems (including the enterprise), each process has sub-processes, sub-sub processes and so on. Each of these in turn has macro process building blocks 130, process conformation building blocks 120, process element building blocks 110 and process activity building blocks 100 in process re-composition levels as shown in FIG. 7B.

### 6. Stream Flow Interdependencies

Enterprise ‘agility’ is the ability to combine/re-combine ‘loosely coupled building blocks’. This may include service-oriented architecture (SOA) building block ‘process service’ components shown in FIG. 7C that may be outsourced to optimize strategic ‘value flow’ propositions. ‘Management’ processes 310 set strategies—business 312, safety 314, leverage 316 and innovation 318—each of which sets objectives, value propositions and core process competencies. The ‘core’ processes balance demand processes 333, 335 with supply processes 337, 339 which in turn define the best mix and balance among ‘enabling’ process resources 363, 365, 367 and 369.

These fundamental process interdependencies 420 are shown in FIG. 8A. They link strategy (planned value flow) with results (execution value flow). While business process management (BPM) applications 399 are intended to integrate all 3 types of processes, BPM may lack success at many process levels in the absence of common process definitions and common maturity methods described in this invention

Overall ‘strategic competitiveness’ value flow shown in FIG. 8B is highly influenced by leverage 317 and innovation 319 management processes. Core processes contribute demand visibility 333 and enabling processes contribute workforce productivity, motivation and culture, especially for human resources 364.

However each of these types of value flow involves many operational, tactical and strategic tradeoffs within and among all 12 processes. For example the innovative capacity 1006 value stream—the ability to create a continuous stream of commercially relevant innovations—includes human resources 362, finance 366, assets 368, market 332, design/make 336 and innovation 318 as shown in FIG. 9. It requires a combination of many interdependent process value stream flows. Likewise, overall enterprise competitiveness value requires combinations of process flows and tradeoffs among them.

### 7. Stream Flow Tradeoffs and Key Performance Metrics

Understanding process interdependencies and making tradeoffs are key to optimizing value flow. Tradeoffs may occur at federation, strategic, tactical, operation and activity levels within processes.

For example, innovation research and development (R&D) ‘ideation’ for new product development and introduction (NPDI) 319 in public/private federations of enterprises—involves balancing investment 440 among public R&D and private R&D processes and human resource processes (highly qualified people—HQP) shown in FIG. 8C. While private R&D may produce new product ‘deal flow’ 15 times that of the public process for equivalent investment, the private process is dependent on the public R&D process for the HQP that undertake the private R&D. Companion US Patent Application 66/305,477 describes this tradeoff between private R&D and public R&D. The best private/public R&D balance is not 15/1 but closer to 3/1 for optimizing overall federation new product opportunity workflow.

Another example of a tradeoff for the manufacturing enterprise relates to customer satisfaction. This may mean trading off high inventories for good order quality, or on the other hand, sacrificing customer responsiveness for low costs. A balance must be struck.

In the prior art, Supply Chain Council SCORcards and Value Chain Group Valuecards define types of key performance metrics. Few align directly with flow stream knowledge benchmarks, ‘types of value flow’ or value flow tradeoffs in the absence of common process definitions and a common benchmarking method.

As shown in FIG. 8A, there are an almost infinite number of re-combination flow interdependency possibilities. Therefore it is important to define a protocol for identifying building block and stream flows and value tradeoffs ‘that matter most’ for optimizing enterprise (and federation of enterprise) ecosystem value. Process benchmarks and stream flows, and process interdependency benchmarks and stream flow tradeoffs may be defined at the operational level, tactical level and strategic level.

### 8. Value Flow Protocol

This invention defines several device protocols based on a common building block framework 1. The first is a common process ontology 2. The second is a common process flow ontology 5. Both are shown in FIG. 10A. The third is a common maturity method 8 for architecture, process, value flow and competitiveness as shown in FIG. 10B.

This invention provides a set of nine elements in an apparatus that may transition between the prior art and a common standard interoperable framework. These include a process ontology 2 that aligns with common process building block arrangements 3 and common types of process interdependency tradeoffs 4. A process flow ontology aligns with process stream flows (stage-to-stage and level-to-level) 6, and process-to-process and service-to-service trade-off flows 7. A common maturity method (for architecture, processes, flows and competitiveness value) aligns with a process benchmark knowledgebase 9 and a process tradeoff benchmark knowledgebase 10 and decision dashboards shown in FIG. 10C.

These ontologies define sets of key performance indicators for processes, flows and flow stream thread values. For each macro process these include stage-to-stage and level-to-level flow KPIs. Process interdependency tradeoff KPIs include category-to-category, process-to-process, level-to-level and stage-to-stage tradeoff flow KPIs as shown in FIG. 11A. Knowledgebase process knowledge benchmark and tradeoff benchmarks also include those shown in FIG. 11B.

What is claimed is:

1. A federation of enterprises and enterprise ecosystem framework structure.

2. An ecosystem framework as in claim 1 wherein an ecosystem is an enterprise system.

3. A system as in claim 2 wherein the system is comprised of building blocks.

4. A system as in claim 3 wherein the building blocks have a common building block structure;

5. A system as in claim 4 wherein the building blocks may be combined and re-combined in loosely coupled sets.

6. A system as in claim 2 wherein the framework structure contains an enterprise architecture and architecture maturity or re-engineering method.

7. A system as in claim 6 wherein the enterprise architecture is common to major architecture reference models in the prior art and may serve to unify them.

8. A system in claim 7 wherein the enterprise architecture maturity method is common to major architecture reference models in the prior art and may serve to unify architecture maturity methods.

9. A system in claim 8 wherein the common maturity method has six steps.

10. A system in claim 9 wherein each of the steps has six common sub-steps that are the same as the six steps in the maturity method.

11. A system in claim 6 wherein the enterprise architecture comprises a business process architecture and process maturity or re-engineering method.

12. A system in claim 11 wherein the business process architecture is a process architecture.

13. A system in claim 12 wherein the architecture define macro processes.

14. A system in claim 11 wherein the business process architecture is common to major process operations reference models in the prior art and may serve to unify them.

15. A system in claim 14 wherein the business process maturity method is common to major process operations reference models in the prior art and may serve to unify process maturity methods.

16. A system in claim 15 wherein the common maturity method is the same as the common maturity method for architecture maturity in claim 8.

17. A system in claim 15 wherein the common maturity method is common to architecture, process, process value stream flow and value competitiveness models in the prior art.

18. A system in claim 2 wherein the framework structure contains an enterprise architecture structure, an architecture maturity method, a process structure, and a process maturity method.

19. A system in claim 18 wherein the maturity methods are common.

20. A system in claim 19 wherein the common maturity method has six steps.

21. A system in claim 20 wherein each of the six steps has six common sub-steps.

22. A system in claim 21 wherein one of the steps is a benchmarking step and the six common sub-steps define a benchmarking method.

23. A system in claim 22 wherein the benchmarking step is based on process knowledge.

24. A system in claim 13 wherein the process architecture has types of process stream flows.

25. A system in claim 24 wherein the stream flows may include workflows that may include materials, goods, services, projects, products, or orders; information flows that may include information, ideas, tacit knowledge, data, communications, collaborations and teamwork; and value flows that may include project, portfolio, economic or shareholder value.

26. A system in claim 25 wherein the process stream flows may be within individual building blocks and/or within a set or sets of linked building blocks.

27. A system in claim 26 wherein the building block arrangements may include process stage-to-stage arrangements or process level-to-level arrangements including activity-to-activity, element-to-element, conformation-to-conformation, activity-to element, activity-to-conformation, activity-to-processes, element-to-conformation, element-to-process, conformation-to-process and/or process-to-process

28. A system in claim 27 wherein any or all of the arrangements may involve stream flows.

29. A system in claim 28 wherein there may be process interdependencies and/or process stream flow interdependencies.

30. A system in claim 29 wherein process stream flow interdependencies influence flows.

31. A system in claim 30 wherein interdependency flow tradeoffs may influence value flows deriving from flow streams involving more than one process.

32. A system in claim 31 wherein enterprise management may make informed value flow tradeoff decisions based upon knowledge of process value stream flows among interdependent processes.

33. A system in claim 32 wherein a preferred ‘to be’ status of value stream flow is defined by process knowledge benchmarks for the optimum value a process flow can be.

34. A system in claim 2 wherein there is a common process ontology, a common process flow ontology and a common maturity method.

35. A system in claim 34 wherein the process ontology is aligned with process building block arrangement definitions and types of process tradeoffs, where the process flow ontology is aligned with stage-to-stage and level-to-level process flows and aligned with tradeoff flows, and where the maturity method is aligned with a process benchmark knowledgebase and a process tradeoff benchmark knowledgebase.

36. A system in claim 2 wherein there is a method of defining and assessing process stream flow, value stream flow and value stream flow tradeoffs.

37. A system in claim 2 wherein there is a computer implemented system for value optimization of a federation of enterprise and/or an enterprise.

38. A system in claim 2 wherein there is a machine readable medium having a plurality of instructions processable by a machine embodied therein to perform a method for informed value stream flow tradeoff analysis.

39. A system in claim 38 wherein a decision dashboard or dashboards display value stream flows, value stream flow benchmarks, flow interdependencies and flow interdependency benchmarks for process activity, element, conformation and process levels.

40. A system in claim 1 that unifies architecture and process reference models, maturity methods, process knowledge benchmarks, and value stream flows and facilitates process interdependency value tradeoff decision-making.

41. A method in claim 1 for standardization of common building blocks.

42. A method in claim 2 wherein the maturity method is a common maturity method that contains a common benchmarking method.

43. A maturity method in claim 2 wherein there are six steps including definition of the ‘as is’ state, the ‘to be’ benchmark state, the variance between them, a solution to address the variance, implementation of the solution, and performance measurement of the effectiveness of the solution.

44. A method in claim 43 wherein the six steps each have the same common six sub-steps.

45. A method in claim 44 wherein step 2 is definition of the ‘to be’ benchmark sub-method.

46. A method in claim 2 for arranging, combining or re-combining building blocks to define stream flows.

47. A method in claim 46 wherein the method defines value flows and value flow interdependencies.

48. A method in claim 47 wherein value flow interdependency tradeoff options may be shown in decision dashboards and evaluated for optimizing value flow outcomes.

49. A method of unifying architecture, process, maturity and competitiveness operations reference models in a common federation of enterprise reference framework.

50. A device in claim 2 for describing the common framework and system features described in claims 1-40.

51. A device in claim 2 wherein a computer protocol facilitates value optimization for a federation of enterprise and an enterprise.

52. A device in claim 2 wherein there is a machine readable medium having a plurality of instructions processable by a machine embodied therein to perform the methods in claims 40-49 to facilitate informed value stream flow tradeoff analysis.
